(19) United States
(12) Patent Application Publication
(10) Pub. No.: US 2010/0288144 A1
(43) Pub. Date: Nov. 18, 2010

(54) PRINTING METHOD BY OFFSET PRINTING PRESS AND OFFSET PRINTING PRESS

(76) Inventors: Yasuharu Suda, Takasago-shi (JP); Mitsuru Tabuchi, Hiroshima (JP); Fumiko Omae, Hiroshima (JP); Koji Nishiyama, Mihara-shi (JP); Ryota Takahashi, Osaka-shi (JP); Yoshiaki Ueno, Osaka-shi (JP)

Correspondence Address: KANESAKA BERNER AND PARTNERS LLP, 1700 DIAGONAL RD, SUITE 310, ALEXANDRIA, VA, 22314-2848, US

(21) Appl. No.: 12/663,758

(22) PCT Filed: Jun. 11, 2008
(86) PCT No.: PCT/JP2008/060664

§ 371 Date: Feb. 16, 2010

(30) Foreign Application Priority Data
Jun. 11, 2007 (JP) 2007-153859

(51) Int. Cl. B41F 7/02

(52) U.S. Cl. 101/217; 101/492

(57) ABSTRACT

The invention relates to a printing method by an offset printing press and an offset printing press by which a substrate process is carried out for low-whiteness printing paper such as paper for newspaper with aqueous substrate treatment agent so that the print quality can be improved. In the invention, in order to suppress occurrence of a curl of printing paper, substrate treatment agent containing solid fine particles and a binder component is supplied to a printing face of printing paper, and the substrate treatment agent is dried to form a porous layer having a great number of holes having a smaller diameter than that of pigment contained in printing ink from the solid fine particles and the binder resin. Then, offset printing is carried out on the printing paper.

### CROSS-REFERENCE TO RELATED APPLICATIONS

The present application is based on International Application No. PCT/JP2008/060664, filed on Jun. 11, 2008, which in turn corresponds to Japanese Application No. 2007-153859, filed on Jun. 11, 2007, and priority is hereby claimed under 35 USC §119 based on these applications. Each of these applications are hereby incorporated by reference in their entirety into the present application.

### TECHNICAL FIELD

The present invention relates to a printing method by an offset printing press and an offset printing press suitable for use with a newspaper rotary press and printing by a newspaper rotary press.

### BACKGROUND ART

In recent years, the print quality of a picture of a color photograph or the like has enhanced drastically. Not only enhancement of a printing technique and enhancement of the quality of printing ink but also enhancement of the quality of printing paper contribute much to the enhancement of the print quality. Conversely speaking, there is the possibility that, where printing paper is limited, for example, as in newspaper printing, required printed picture quality may not be sufficiently obtained.

In particular, the whiteness (or brightness) of printing paper for newspaper for use with a newspaper rotary press is lower than that of the other printing paper. Further, in the case of printing paper for newspaper, featherweight paper having low grammage is used taking the transportability into consideration, and still more reduction in weight of paper is advancing in response to a flow of increase of pages. Therefore, also the opacity of the paper drops in comparison with that of the other printing paper.

While such a fact that the whiteness, opacity and so forth of the paper for newspaper are reduced as described above does not make a significant obstacle to printing of an article region, it gives rise to a fault in the case of color printing regarding a color photograph or the like or in a case wherein there is a high line rate printing region over a certain degree of wideness. In particular, since white color of paper itself is utilized in color printing, if the whiteness of paper is low, then a color tone different from a required color tone is obtained at least at the low-whiteness region. Further, if the opacity of the paper is low, then a printing fault such as strike-through is likely to appear on the reverse side of the high line rate printing region. Particularly, if the total ink amount for printing plates (totaling four plates) in color printing is over 250%, then a printing fault such as strike-through is likely to appear. If strike-through appears, then color reproducibility deteriorates.

Further, in color printing of newspapers, while organic pigment which allows reproduction of clear color is used as color ink for cyan (C), magenta (M) and yellow (Y), since the organic pigment has a characteristic that hiding power is low, it is likely to be influenced by the color of the substrate.

As a result, in color printing of newspapers, the colors of cyan, magenta and yellow (CMY) become dull by an influence of grayish color of paper for newspaper which is the substrate. Therefore, although organic pigment having good color reproducibility is used, the color reproduction range is narrowed and sufficient color reproducibility cannot be achieved.

Further, even if such strike-through as described above does not appear, it cannot be avoided that a phenomenon (drydown) occurs that, in general paper for newspaper, ink (particularly, pigment) on the paper face sinks into clearances of paper fibers in several hours after printing and the print density drops. It is considered that also the drydown makes one of causes of the reduction of the color reproduction range.

Further, in case of paper for newspaper, since the smoothness on the paper face is insufficient, ink cannot uniformly adhere to the paper face and absence of the ink is likely to appear. It is considered that the phenomenon just described causes reduction of the printing density, that is, reduction of the color reproduction range.

Further, in case of paper for newspaper, since the CMYK ink runs and spreads along the orientation of fibers on the paper surface, the dot gain remarkably appears particularly in a halftone region of a tone value of approximately 30% to 60% and a tendency appears that the halftone dot area increases by approximately 15% to 30%. Also the phenomenon just described causes reduction of the gradation reproducibility and disturbs improvement of the picture quality.

Therefore, under the present conditions, in order to satisfy a request for the picture quality of a region printed in color for which high picture quality is requested, a countermeasure is taken to replace a region which cannot satisfy the request for a white region or another region in which strike-through is likely to appear in case of normal paper for newspaper with different paper for newspaper which has high whiteness.

However, since, in the case of paper for newspaper having high whiteness, in order to enhance the whiteness of the paper for newspaper, the paper is produced by carrying out fine coating or application of white material at a stage of papermaking, the price increases and this increases the cost. Particularly, if the replacement of the paper is carried out as described above, then, for example, paper of a high price having high whiteness is used in regard to the reverse face for which replacement of paper is not required and also in regard to a region on the same face for which replacement of paper is not required such as an article region.

Further, while there is an example wherein an advertisement is printed on printing paper for advertisement which has high whiteness and is different from paper for newspaper and the paper is used as an inserted flyer to newspaper, the price of the printing paper for advertisement is high and insertion of the paper into newspaper requires time and labor, and increase of the cost cannot be avoided.

On the other hand, in Patent Document 1, a technique is proposed wherein, where characters and a photograph are printed on the same printing field using paper having low smoothness, low opacity and low whiteness such as paper for newspaper, by carrying out printing after printing field improvement agent for enhancing the smoothness, opacity and whiteness is partially processed in a photograph printing region on the printing field, a photograph is printed clearly while paper for newspaper is used.

Further, in Patent Document 2, a technique is proposed wherein, for normal paper for newspaper having low whiteness, white-based ink is placed beforehand and processed in a region in which a photograph or advertisement is to be printed and then printing is carried out so that an advertisement, a photograph or the like is printed with a required color tone while the paper for newspaper is used.

Patent Document 1: Japanese Patent Publication No. Sho 45-25649

Patent Document 2: Japanese Patent Laid-Open No. Hei 2-117877

### DISCLOSURE OF INVENTION

### Subject to be Solved by the Invention

Incidentally, in case of printing paper wherein clearances of paper fibers are comparatively great such as paper for newspaper, as described above, it cannot be avoided that a phenomenon (drydown) occurs that ink (particularly, pigment) on the paper face sinks into clearances of paper fibers during several hours after printing and the printing density drops. Also by this drydown, the pigment density per a unit volume in an ink layer drops, and therefore, this phenomenon makes a cause of narrowing of the color reproduction range.

FIGS. 13(a) and 13(b) are conceptual views illustrating behavior of ink applied to a paper face. As shown in FIGS. 13(a) and 13(b), printing ink 20 contains at least pigment 21 as coloring agent, binder resin (binder component) 22 and solvent 23. While an ink layer formed from the ink 20 contains all of the pigment 21, binder resin 22 and solvent 23 immediately after it is applied to the printing paper 10 as seen in FIG. 13(a), the solvent 23 is removed as seen in FIG. 13(b) as a drying step advances.

At the drying step, drying of the substrate treatment agent is achieved while infiltration of the solvent 23 into the printing paper 10 and volatilization or evaporation of the solvent 23 into the atmosphere advance at the same time.

However, when the solvent 23 infiltrates into the printing paper 10, although the pigment 21 should originally be kept on the surface in the printing area of the printing paper 10, part of the pigment 21 infiltrates into clearances of paper fibers in the printing paper 10 and is hidden behind the paper surface in the printing region, and drydown occurs.

In the conventional techniques disclosed in Patent Documents 1 and 2 described above and so forth, an effective countermeasure against the drydown is not disclosed, and development of a technique for suppressing occurrence of the drydown is desired.

The present invention has been made in view of such a subject as described above, and it is an object of the present invention to provide a printing method by an offset printing press and an offset printing press by which occurrence of drydown on a paper face on which the drydown is likely to appear such as a paper face of paper for newspaper can be suppressed.

In order to achieve the object described above, according to the present invention, there is provided a printing method by an offset printing press, comprising a substrate treatment agent supplying step of supplying substrate treatment agent containing solid fine particles and a binder component at least to a printing face of printing paper, a drying step of drying the printing face to which the substrate treatment agent is supplied, and a printing step of carrying out offset printing on the printing face, and wherein, by drying the printing face at the drying step, a porous layer having a great number of holes with a smaller diameter than that of particles of pigment contained in printing ink is formed from the solid fine particles and the binder component contained in the substrate treatment agent.

It is to be noted that the holes with a smaller diameter than that of particles of pigment included in printing ink are holes of a diameter with which the pigment cannot pass through the porous layer. The holes formed in the porous layer may be three-dimensional holes and may be formed with a diameter with which the pigment cannot pass some of the holes which extend from one face to the other face of the porous layer through the porous layer. Further, although it is not essentially necessary for all of the holes formed in the porous layer to be formed with a small diameter with which the pigment cannot pass through the porous layer, preferably a number of ones of the holes formed in the porous layer as great as possible are formed so as not to allow the pigment to pass through the porous layer.

Further, according to the present invention, there is provided an offset printing press for carrying out offset printing on printing paper, comprising a substrate treatment agent supplying section provided on the upstream side with respect to a blanket drum nip section for a first color of a printing section and adapted to supply substrate treatment agent containing solid fine particles and a binder component to a printing face of the printing paper, and a drying processing section provided on the upstream side with respect to the blanket drum nip section for the first color of the printing section but on the downstream side with respect to the substrate treatment agent supplying section and adapted to carry out a drying process for the substrate treatment agent supplied to the printing face to form a porous layer having a great number of holes with a smaller diameter than that of particles of pigment contained in printing ink from the solid fine particles and the binder component contained in the substrate treatment agent.

A weight ratio between the solid fine particles and the binder component contained in the substrate treatment agent, as represented by solid fine particles/binder component, preferably is 20/1 to 2/1, and more preferably is 10/1 to 5/1.

Where the weight ratio defined as above is used, the holes to be formed in the porous layer can be formed readily with a size of a smaller diameter than that of popular pigment included in printing ink, and the drydown can be suppressed with a higher degree of certainty.

A primary particle size of the solid fine particles preferably is 0.05 to 0.5 μm, and more preferably is 0.1 to 0.3 μm.

Where the primary particle size defined as above is used, the holes to be formed in the porous layer can be formed readily with a size of a smaller diameter than that of popular segment included in printing ink, and the drydown can be suppressed with a higher degree of certainty.

Preferably, the solid fine particles of the substrate treatment agent are white pigment.

Where the solid fine particles are white pigment, the color reproduction range of a color-printed region can be increased with certainty, and a color print can be printed efficiently with high reproducibility.

Preferably, the region of the printing paper to which the substrate treatment agent containing the white pigment is supplied has, in a region thereof in which the substrate treatment layer is exposed after the offset printing ends, whiteness of 60% or more.

Preferably, the printing paper is low-whiteness printing paper and the offset printing press is a newspaper rotary press.

Where the printing paper is low-whiteness printing paper and the offset printing press is a newspaper rotary press, the drydown is likely to occur and the color reproduction range of a color-printed region is likely to reduce, resulting in degradation of the color reproducibility of a color print. However, since the porous layer having a large number of holes with a diameter smaller than that of the pigment included in the printing ink is formed, the drydown is suppressed and a sufficient color reproduction range can be assured.

### EFFECT OF THE INVENTION

With the printing method by an offset printing press and the offset printing press of the present invention, the substrate treatment agent is supplied to the printing face of printing paper such that a porous layer having a great number of holes with a smaller diameter than that the pigment contained in the printing ink is formed from solid fine particles and a binder component contained in the substrate treatment agent and then printing is carried out. Therefore, although the solvent contained in the printing ink transferred on the printing face is infiltrated into the printing paper through the small diameter holes of the porous layer, the pigment contained in the printing ink is blocked by the porous layer and is retained on the printing face. By the infiltration of the solvent into the printing paper through the small diameter holes of the porous layer, drying of the printing ink on the printing face is accelerated while the pigment contained in the ink is retained on the printing face. Consequently, the phenomenon (drydown) that the printing density decreases is suppressed and a sufficient color reproduction range is secured. As a result, particularly color printing can be carried out with high color reproducibility and with a higher definition.

### BRIEF DESCRIPTION OF THE DRAWINGS

FIG. 1 is an explanatory view showing a configuration of essential part of an offset printing press according to a first embodiment of the present invention.

FIGS. 2(a) and 2(b) are conceptual views illustrating a forming process of a porous layer by substrate treatment agent supplied to a printing face of printing paper according to embodiments of the present invention, and wherein FIG. 2(a) illustrates a state immediately after substrate treatment agent is applied and FIG. 2(b) illustrates a state after a porous layer is formed with the substrate treatment agent.

FIGS. 3(a) and 3(b) are conceptual views relating to behavior of printing ink transferred to the printing face of the printing paper according to the embodiments of the present invention, and wherein FIG. 3(a) illustrates a state before the printing ink is dried and FIG. 3(b) illustrates a state after drying of the printing ink advances.

FIG. 4 is a schematic structure view illustrating a distance between solid fine particles contained in the substrate treatment agent according to the embodiments of the present invention.

FIG. 5 is a front elevational view showing a printing face of paper for newspaper according to the first embodiment of the present invention.

FIG. 6 is a flow chart illustrating a printing method by the offset printing press according to the first embodiment of the present invention.

FIG. 7 is a view illustrating experiments according to the embodiments of the present invention and illustrating a relationship between the dried film thickness and the whiteness of white ink.

FIGS. 8(a) to 8(d) are views illustrating experiments according to the embodiments of the present invention, and wherein FIGS. 8(a) to 8(d) individually illustrate a relationship between the whiteness and the solid density of printing paper.

FIG. 9 is a view illustrating experiments according to the embodiments of the present invention and illustrating a relationship between the whiteness of paper for newspaper and color reproduction ranges of ink colors.

FIG. 10 is a view illustrating experiments according to the embodiments of the present invention and illustrating a relationship between the whiteness and the dot gain of the printing paper.

FIG. 11 is a view showing a configuration of essential part of an offset printing press according to a second embodiment of the present invention.

FIG. 12 is a view showing a configuration of essential part of an offset printing press according to a third embodiment of the present invention.

FIGS. 13(a) and 13(b) are conceptual views regarding behavior of the printing ink transferred to the printing face of the printing paper and illustrating a subject of the present invention, and wherein FIG. 13(a) shows a state before drying of the printing ink and FIG. 13(b) shows a state after drying of the printing ink advances.

### DESCRIPTION OF REFERENCE CHARACTERS

1 paper supplying section
1a roll paper
2 in-feed section
2a in-feed roller
2b dancer roller
3a, 3b, 3c guide roller
4 substrate treatment agent supplying apparatus
4A substrate treatment agent processing section
4B drying processing section
4a, 4c substrate treatment agent supplying roll
4b, 4d printing drum
5a, 4b heating apparatus
6 printing section (printing apparatus)
7 floating roller
10 paper (web) for newspaper as printing paper
11a, 11b printing face (printing page)
12 region in which article is printed
13 printing region of photograph
14 printing region of advertisement
15 water supplying region
20 printing ink
21 ink pigment
22 binder resin
23 solvent
30 porous layer
30′ substrate processing layer
31 solid fine particle (white pigment) and binder resin (binder component)
32 small diameter hole (pore)

### BEST MODE FOR CARRYING OUT THE INVENTION

In the following, embodiments of the present invention are described with reference to the drawings.

### First Embodiment

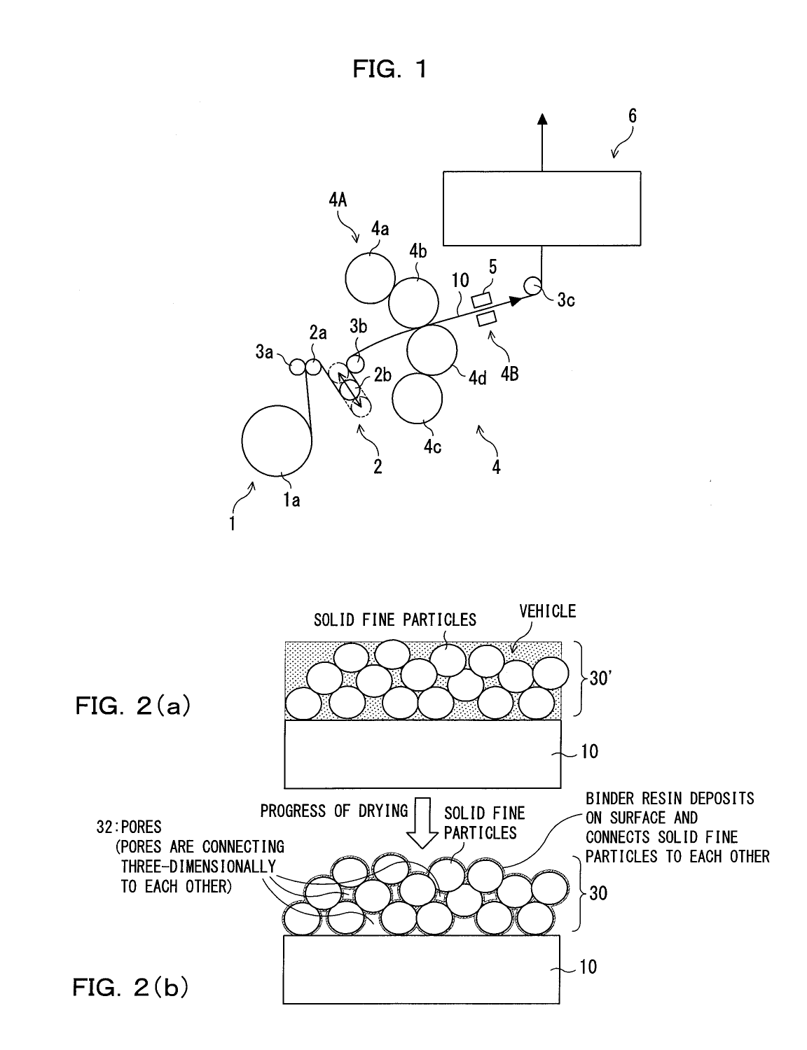

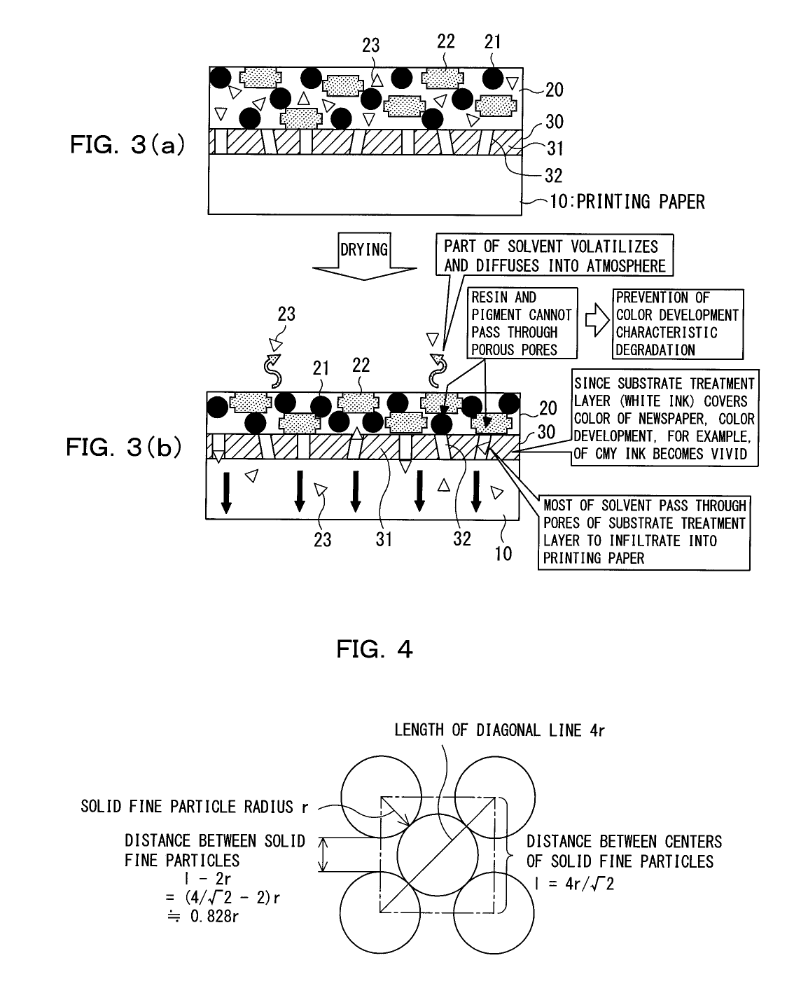

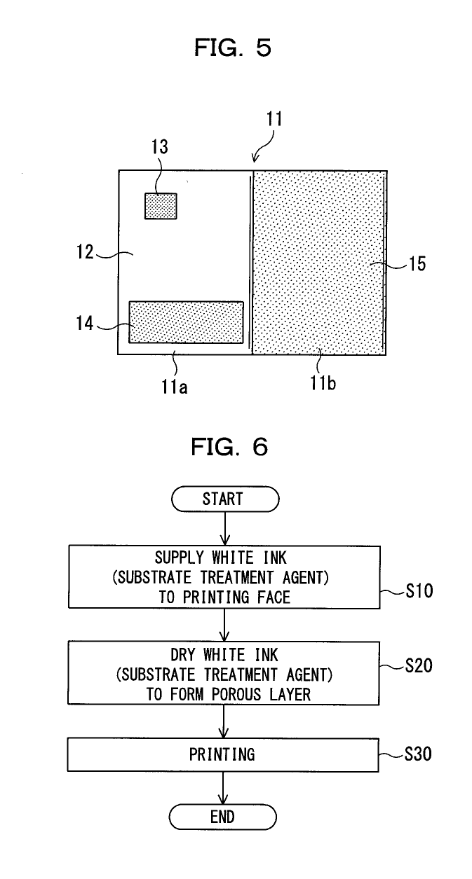

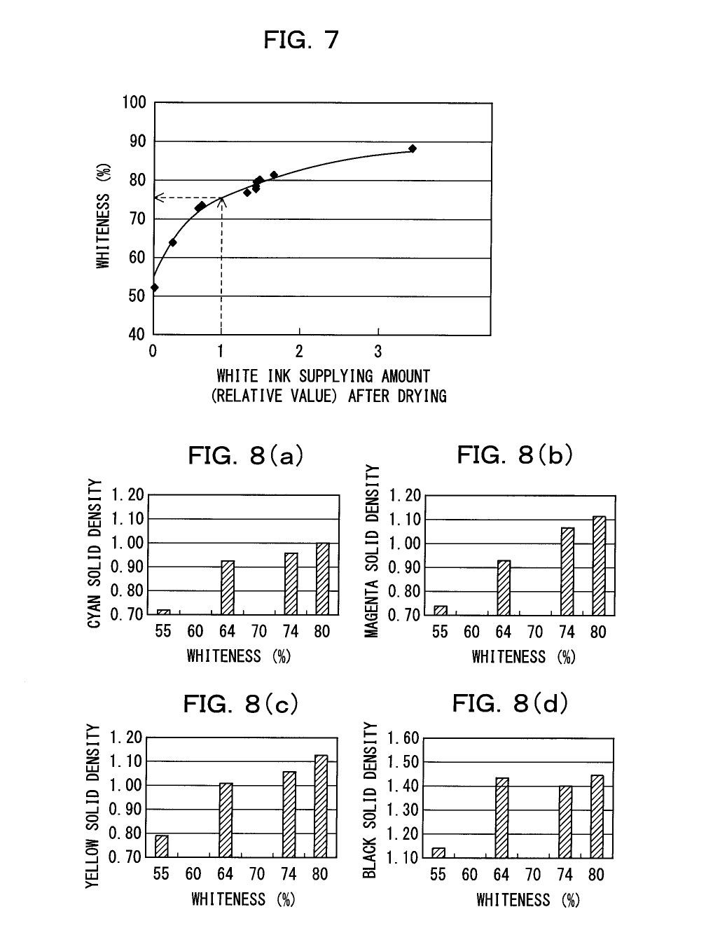

First, a first embodiment of the present invention is described. FIGS. 1 to 10 illustrate the first embodiment of the present invention, and wherein FIG. 1 is an explanatory view showing a configuration of essential part of an offset printing press of the present embodiment and FIGS. 2(a) and 2(b) are conceptual views illustrating a forming process of a porous layer with substrate treatment agent supplied to the printing face. FIGS. 3(a) and (b) are conceptual views regarding drying of moisture supplied to the reverse face and the substrate treatment agent supplied to the printing face and FIG. 4 is a schematic structure view illustrating a distance between solid fine particles contained in the substrate treatment agent. Further, FIG. 5 is a front elevational view showing a printing face of the paper for newspaper and FIG. 6 is a flow chart illustrating a printing method by the offset printing press. Further, FIGS. 7 to 10 are views illustrating experiments according to the present embodiment.

The present embodiment relates to a newspaper rotary press as the offset printing press, and, as shown in FIG. 1, a substrate treatment agent supplying apparatus 4 for supplying substrate treatment agent, which contains solid fine particles and binder resin (binder component) therein, to a printing face of paper 10 for newspaper (hereinafter referred to sometimes as web) in the state of a web as printing paper is added on the upstream side of a printing section (printing apparatus) 6 of the newspaper rotary press.

While the substrate treatment agent is used for forming a porous layer having a great number of holes with a smaller diameter than that of pigment contained in printing ink from solid fine particles and binder resin contained therein, the present embodiment is described taking a case wherein white pigment is used as the solid fine particles included in the substrate treatment agent as an example. It is to be noted that, while, for example, general paper having whiteness of 54 to 55% and grammage of approximately 42 to 44 g/m² is used as the paper (web) 10 for newspaper, the paper (web) 10 for newspaper is not limited to this.

In particular, the newspaper rotary press transports the web 10 installed as roll paper 1a in a paper supplying section 1 and delivered from the in-feed section 2 to the printing section 6 and transfers required color ink by means of a printing unit (not shown) provided on the printing section 6 and then outputs the web 10 as a folded document through a cooling section, a web-path section and a folding machine (not shown).

The in-feed section 2 includes an in-feed roller 2a, a dancer roller 2b for adjusting the tension of the web 10 by movement thereof to change the web-path distance, a guide roller 3a disposed in an opposed relationship with the in-feed roller 2a across the web 10, and a guide roller 3b disposed on the side from which the web 10 runs out from the dancer roller 2b, and delivers the web 10 toward the printing section 7 while maintaining the state of the web 10 in a set state.

It is to be noted that, while a single printing unit is provided in the printing section 6 in a case of single-color printing, a plurality of printing units are provided here so as to carry out multi-color printing such as full-color printing or the like.

The substrate treatment agent supplying apparatus 4 described above is added to a location on the downstream side with respect to the dancer roller 2b which is an apparatus for varying the web-path length of the in-feed section 2 in an existing newspaper rotary press but on the upstream side with respect to a first-color blanket drum nip section (not shown) of the printing apparatus (here, on the upstream side with respect to the location of a guide roller 3c at an entrance of the printing section 6).

It is to be noted that, while the present embodiment is configured such that the substrate treatment agent supplying apparatus 4 is added to an existing printing press, it is a possible idea that, as a configuration for utilizing an existing printing press still more effectively, the guide roller 3b shown in FIG. 1 is used in place of a pressure drum of the substrate treatment agent supplying apparatus.

The substrate treatment agent supplying apparatus 4 includes a substrate treatment agent processing section 4A and a drying processing section 4B.

The substrate treatment agent supplying section 4A is configured similarly to a popular printing unit for offset printing and includes substrate treatment agent supplying rolls 4a and 4c for supplying the substrate treatment agent to a printing plate and printing drums 4b and 4d on which the printing plate is mounted corresponding to a printing region of the substrate treatment agent. Further, as occasion demands, a printing drum may be provided at the position of the substrate treatment agent supplying rolls 4a and 4c and a transfer drum for transferring the substrate treatment agent received from the substrate treatment agent supplying rolls 4a and 4c to the surface (printing face) of the web 10 may be provided at the position of the printing drums 4b and 4d. As the transfer drum in this instance, a drum corresponding to a blanket drum of a commercial offset rotary press (commercial offset) or a newspaper rotary press may be used.

Here, since the substrate treatment agent is transferred to both faces of the web 10, a first substrate treatment agent supplying system having a substrate treatment agent supplying roll 4a and a printing drum 4b is disposed on one face side of the web 10 and a second substrate treatment agent supplying system having a substrate treatment agent supplying roll 4c and a printing drum 4d is disposed on the other face side of the web 10. Therefore, where the substrate treatment agent is transferred only to one face side of the web 10, the substrate treatment agent supplying system on the unnecessary side may be set not to be used or it may be set that the substrate treatment agent supplying system on the unnecessary side is not mounted in advance.

Further, the drying processing section 4B provided on the downstream side in the substrate treatment agent supplying apparatus 4 dries the substrate treatment agent transferred to the printing face of the web 10, and the heating apparatus 5 for heating and drying the substrate treatment agent is provided in the drying processing section 4B in the present embodiment.

It is to be noted that, for the heating apparatus 5, various methods such as a warm air method for drying the web 10 by blowing warm air to the printing face of the web 10, a vapor method for drying the web 10 by blowing high-temperature vapor to the printing face of the web 10, a method for irradiating infrared rays, a combination of the methods just described (all of the methods are non-contacting methods), a high-temperature roll method wherein a high-temperature roll is contacted with the printing face of the web 10 so as to rotate at a circumferential speed synchronized with that of the web 10 or the like can be applied.

Here, heating drying can be carried out not only for the printing face but also for the reverse side to the printing face by all of the warm air method, vapor method, infrared ray irradiation method and high-temperature roll method. Further, where the type of the substrate treatment agent is an energy beam curing type by an electron ray, an ultraviolet ray or the like, the heating apparatus 5 can be configured as a drying apparatus by an electron ray or an ultraviolet ray irradiation.

Particularly since, if high-temperature vapor is suitably used, then a fault of contraction of the web by moisture reduction by heating of the web 10 is prevented, it is preferable to use the high-temperature vapor. For example, it is possible to apply a contacting method for contacting a high-temperature roller with the web, and also it is possible to provide a high-temperature roller separately. Further, also it is possible to dry the web with a contacting method by causing the guide roller 3C to generate heat. Here, a non-contacting method wherein the warm air method and the high-temperature vapor method are mixed with each other is used.

Here, the substrate treatment agent and formation of the porous layer from the same which are characteristics of the present invention are described.

In the substrate treatment agent, white pigment as solid fine particles and binder resin are contained in solvent components. As shown in FIG. 2(a), in a substrate treatment layer 30′ immediately after it is supplied to the printing paper, the solid fine particles (here, white pigment) are piled up and a vehicle (mixture of the binder resin and solvent) of the substrate treatment agent fills clearances between solid fine particles. If drying of the substrate treatment layer (infiltration of the solvent components into the printing paper and vaporization of the solvent) advances, then the binder resin in the vehicle begins to deposit on the surface of the solid fine particles. Further, if the drying advances still more and then the solvent components decrease, then cavities are formed between the solid fine particles as shown in FIG. 2(b). The cavities function as pores 32 three-dimensionally connected to each other. As a result, as schematically shown in FIGS. 3(a) and 3(b), the solid fine particles (white pigment) and the binder resin are coupled to each other (refer to reference numeral 31) to form a porous layer 30 having a great number of cavities (small diameter holes or pores) 32.

While it is necessary for the diameter of each of the small diameter holes 32 of the porous layer 30 to be smaller than that of the pigment contained in the printing ink (to be a diameter with which the pigment contained in the printing ink cannot pass the holes 32), the diameters of the small diameter holes 32 of the actually formed porous layer 30 are not uniform to each other but have some dispersion. Therefore, the [diameter smaller than that of the pigment] referred to here signifies a diameter with which the pigment cannot pass the porous layer. Each hole formed in the porous layer is a three-dimensional cavity and need to be formed with a diameter with which the pigment cannot pass a hole penetrating from one face to the other face of the porous layer. Further, while all of the holes formed in the porous layer may not be formed to individually have a small diameter with which the pigment cannot pass the porous layer, it is preferable to form as many holes as possible in the porous layer to individually have a diameter with which the pigment cannot pass the porous layer.

In order to form the small diameter holes 32 having such a condition as described above in the porous layer 30, it is preferable to set the weight ratio (=solid fine particles/binder resin) between the solid fine particles of the substrate treatment layer and the binder resin of the substrate treatment agent to approximately 20/1 to 2/1 and it is more preferable to set the weight ratio to approximately 10/1 to 5/1. If the weight ratio of the solid fine particles is higher than 10/1, then the binder resin becomes insufficient and the porous layer 30 becomes weak. Further, if the weight ratio of the solid fine particles is higher than 20/1, then the binder resin becomes insufficient and then the porous layer 30 becomes very weak. Taking higher practicability into consideration, it is preferable to suppress the weight ratio to 10/1 or less. Further, the binder resin increases excessively and it is difficult to form pores and then the porosity decreases. Particularly, the small diameter holes 32 infiltrate the solvent of the printing ink into the inside of the printing paper and contributes to accelerating drying of the printing ink as hereinafter described. Therefore, assurance of the porosity is important for improvement of the quality of printing (particularly of high-speed printing). From this point, it is preferable to set the weight ratio to 2/1 or more and, in order to secure still more sufficient porosity, it is preferable to set the weight ratio to 5/1 or more.

Further, it is difficult to secure sufficient porosity if the primary particle size of each solid fine particle is too small and infiltration of the solvent into the paper face side is less likely to be achieved. If the primary particle size of each solid fine particle is too great, then the diameter of small diameter holes becomes great and infiltration of the pigment contained in the printing ink into the paper face side is to be achieved easily. From such a point of view as described above, also it is preferable to set the primary particle size of each solid fine particle to 0.05 to 0.5 μm, and it is more preferable to set the diameter to 0.1 to 0.3 μm.

Such setting of the primary particle size of the solid fine particle as described above is carried out from such a reason as given below. In particular, it is required that the pore diameter in the porous layer formed from the substrate treatment agent of the present invention has a size with which the ink pigment cannot pass the porous layer. Regarding the particle size of the ink pigment, a parameter such as optimum pigment size can be referred to.

Regarding the optimum pigment particle size, for example, in technical library of the DIC corporation (Kazuo Igarashi and Norihisa Noguchi, “Pigment dispersion in printing ink” [DIC Technical Review 1997 No. 3] [searched May 16, 2007], Internet <URL: http://www.dic.co.jp/rd/tech/rev0303/index/html>), description is found that, “while a primary particle immediately after composition in pigment in CMYK ink is as fine as 0.02 to 0.2 μm, since aggregation occurs at a filtration step or the like in a pigment fabrication process, the size of the primary particle becomes 0.5 to 2 μm. When further powdering is carried out, if dehydration and drying are carried out, then aggregation occurs and the pigment becomes a grape-like aggregate of 40 to 100 μm. In a fabrication process of printing ink, pigment aggregated in such a manner as just described is re-dispersed. However, taking an optical characteristic of the pigment particle size into consideration, more fined pigment is not preferable as ink, but it is considered appropriate to set the particle size in the pigment aggregate to a size from substantially one half the wavelength of a visible ray to a value substantially equal to the wavelength. In particular, cyan (C): 0.4 to 0.7 μm, yellow (Y): 0.3 to 0.6 μm, magenta (M): 0.2 to 0.5 μm and black (K): 0.3 to 0.6 μm are optically optimum pigment particle size.”.

Therefore, the particle size of the pigment in CMYK ink is set to the optimum pigment particle sizes recited as above, that is, to 0.4 to 0.7 μm for cyan (C), 0.3 to 0.6 μm for yellow (Y), 0.2 to 0.5 μm for magenta (M) and 0.3 to 0.6 μm for black (K).

As described above, it is required that each small diameter hole in the porous layer formed from the substrate treatment agent of the present invention is smaller than the optimum pigment particle size.

Here, considering a case wherein the solid fine particles in the porous layer are packed most closely as spheres individually having the same size (radius is r), such a packed state as shown in FIG. 4 appears.

Here, it can be considered that the pore diameter d in the porous layer corresponds to the distance t between solid fine particles shown in FIG. 4 (d≈t). It is to be noted here that, while a case is considered wherein there is no deposited resin on the surface of the solid fine particles, since the dispersion resin actually adheres to the surface of the solid fine particles, the distance t between the solid fine particles, that is, the pore size d, reduces by an amount equal to the thickness of the dispersion resin.

It is to be noted that the distance I between the centers of the solid fine particles adjacent each other but spaced by the distance t between the solid fine particles can be represented by an expression (1) given below and the distance t between the solid fine particles can be represented by an expression (2) given below:

1=4r/√2 (1)

t=1−2r=(4/√2−2)r≈0.828r (2)

Here, where the primary particle size 2r of the solid fine particles is 0.5 μm, the pore size is 0.21 μm and, where the deposition resin on the surface of the solid fine particles is taken into consideration, the pore size is less than 0.21 μm. It is recognized that, if the values of the diameters mentioned are compared with minimum values of the optimum pigment particle sizes of the pigment in the CMYK ink, then almost all pigment described above cannot pass the pores. Therefore, if an upper limit to the primary particle size 2r of the solid fine particles is set to 0.5 μm, then infiltration of the pigment contained in the printing ink into the paper face side can be prevented.

However, even if the particle size of the pigment in CMYK ink is set within the ranges of the optimum pigment particle size for cyan (C): 0.4 to 0.7 μm, yellow (Y): 0.3 to 0.6 μm, magenta (M): 0.2 to 0.5 μm and black (K): 0.3 to 0.6 μm, the pigment whose particle size is smaller than the average particle size is contained. Therefore, it is more preferable to set the upper limit to the primary particle size 2r of the solid fine particles to 0.3 μm.

On the other hand, it is considered that, in order to secure the porosity capable of implementing smooth infiltration of the solvent into the paper face side, the lower limit to the primary particle size of the solid fine particles is set to approximately 0.05 μm or more [pore diameter in this case is approximately 0.021 μm or more from the expression (2)] and, in order to secure the porosity with still more certainty, the lower limit is set to approximately 0.1 μm or more [pore diameter in this instance is approximately 0.042 μm or more from the expression (2)]. In particular, there is the possibility that, if the pore diameter is too small, then the solvent may cause reduction of the infiltration speed to increase drying time of the printing ink and the web 10 may advance to a next process in a state wherein drying of the printing ink is insufficient. However, it is considered that, if the lower limit to the primary particle size 2r is set to approximately 0.05 μm (corresponding to the pore size: approximately 0.021 μm), then, at a general printing speed, the printing ink is placed into a required drying state before the web 10 advances to the next process.

It is to be noted here that, for example, a comparatively high printing speed of approximately 6.9 to 11.5 m/sec (the number of printing copies is 90,000 to 150,000 copies/time) which is a normal printing speed in a newspaper rotary press is assumed as the general printing speed. However, in recent years, taking a newspaper rotary press as an example, a higher printing speed of approximately 11.5 to 13.8 m/sec (the number of printing copies is 150,000 to 180,000 copies/time) is achieved. Thus, also in a case wherein still more increase of the printing speed in such a manner as just described advances, where it is considered so that a sufficient drying speed corresponding to the higher printing speed is obtained, it is preferable to set a lower limit value to the primary particle size 2r of the solid fine particles to as high as approximately 0.1 μm (corresponding to the pore size: approximately 0.042 μm).

Accordingly, the suitable range of the primary particle size of the solid fine particle is set preferably to a range from 0.05 to 0.5 μm, and more preferably, the suitable range is set to a range from 0.1 to 0.3 μm.

It is to be noted that, where titanium oxide which is white pigment is applied to the solid fine particles, the optimum particle size of the titanium oxide is 0.2 to 0.3 μm [pore diameter in this is 0.041 to 0.124 μm from the expression (2)] from a point of view of the whiteness, and the more preferable range of 0.1 to 0.3 μm given hereinabove is satisfied. Therefore, pores can be formed through which the ink pigment is not easy to pass while infiltration of the solvent is easy to be achieved thereby.

Further, as regards the white pigment used here, the refractive index of general rutile titanium oxide is 2.71 and the difference of the refractive index from that of the resin is great, and since refraction of light on an interface between the binder resin and the titanium oxide fine particle is great where the white pigment is used as the ink, the whiteness is high. However, the white pigment is not limited to titanium oxide. For example, while the refractive index of zinc oxide is 1.95 and the whiteness of the zinc oxide is lower than that of titanium oxide, zinc oxide may be used as occasion demands. Further, one kind of white pigment may be used or plural kinds of white pigment may be used at the same time. It is to be noted that substrate treatment agent containing white pigment as solid fine particles is hereinafter referred to sometimes as white ink.

It is to be noted that, for example, for the substrate treatment agent like white ink, the viscosity of 0.01 to 50 P in a reference state (temperature state of 20° C. under the atmospheric pressure) is suitable especially for supplying of the substrate treatment agent using a roller. In particular, if the viscosity becomes higher than approximately 50 P, then the substrate treatment agent becomes too hard and transfer of ink through the roller becomes difficult. On the other hand, in order to prevent the transportability of the substrate treatment agent by the roller from degrading to such a degree that supplying of the substrate treatment agent is becomes difficult, it is preferable to set a lower limit to the viscosity of the substrate treatment agent, for example, to viscosity of approximately 0.01 P corresponding to that of water.

Now, the characteristic of the solvent in the substrate treatment agent which has an influence on the drying characteristic of the substrate treatment agent is described.

At a drying step, drying is carried out by two steps of an infiltration step (infiltration process) of the solvent contained in the substrate treatment agent into printing paper and a vaporization step (vaporization process) of the solvent into the atmosphere as described hereinabove.

The substrate treatment agent contains at least pigment as solid fine particles, binder resin and solvent. While a substrate treatment layer formed from the substrate treatment agent contains all of the pigment, binder resin and solvent immediately after the substrate treatment agent is applied to the printing paper 10, the solvent is removed as the drying step advances.

At the drying step, the drying of the substrate treatment agent is achieved while infiltration of the solvent into the printing paper and diffusion of the solvent into the atmosphere by vaporization advance at the same time. At this time, naturally forming of the porous layer by the drying of the substrate treatment agent is quickly achieved as the printing paper is quickly infiltrated with the solvent and as the solvent is quickly vaporized.

In order to supply the substrate treatment agent to the printing face of the printing paper on the printing press to print an image or characters with printing ink transferred subsequently by the printing section 6, the drying speed of the substrate treatment agent must be sufficiently high and the solvent of the substrate treatment agent is selected so as to assure a high drying speed. As the reference of the selection, the viscosity and the vaporization speed of the solvent at room temperature make the points.

In order to reduce the burden on the heating apparatus or the like for drying the substrate treatment agent and complete the drying of the substrate treatment agent at an ordinary temperature and in short time (in a short feeding distance interval of the printing paper), for example, without using the heating apparatus, the infiltration speed into paper is at least 5 ml/m²·sec or more, and preferably the infiltration speed is 5 ml/m²·sec or more. Further, the viscosity of the solvent at this time is 5 cP or less, and preferably is 3 cP or less and more preferably is 1 cP or less.

Further, there is a tendency that basically the vapor pressure at the room temperature becomes higher and the vaporization speed at the room temperature increases as the viscosity of the solvent decreases.

In order to reduce the burden on the heating apparatus or the like for drying the substrate treatment agent and complete the drying of the substrate treatment agent at an ordinary temperature and in short time (in a short driving distance interval of the printing paper), for example, without using the heating apparatus, preferably the vapor pressure of the solvent is at least 1 mmHg or more, and preferably is 10 mmHg or more and more preferably is 50 mmHg or more.

Accordingly, in order to dry the substrate treatment agent such as white ink before printing ink is transferred to the printing paper (web) by the printing section 6, the viscosity and the vapor pressure of the solvent suitably used in the substrate treatment agent in the present invention are 5 cP or less and 1 mmHg or more under the atmospheric pressure in a 20° C. temperature state, respectively. Preferably, the viscosity and the vapor pressure of the solvent are 3 cP or less and 10 mmHg or more under the atmosphere pressure in a 20° C. temperature state, respectively. More preferably, the viscosity and the vapor pressure of the solvent are 1 cP or less and 50 mmHg or more under the atmosphere pressure in a 20° C. temperature state, respectively. Naturally, the combination of optimum regions of the viscosity and the vapor pressure is not limited to this, and the viscosity may be limited more strictly or the vapor pressure may be limited more strictly.

It is to be noted that the drying state in the present invention signifies a state wherein at least the substrate treatment agent on the printing field is not mixed with the printing ink transferred by the printing section 6 until it causes muddiness in the printing ink, and all of the solvent within the substrate treatment agent need not be transferred from the substrate treatment layer on the printing field to the printing paper or into the atmosphere. Accordingly, the solvent for enhancing the drying characteristic may be contained by 1 to 30% by weight in the substrate treatment agent. Where the content of the solvent just described is less than 1%, the effect of the drying characteristic enhancement is not developed. On the other hand, there is the possibility that, where the content of the solvent described above is 30% or more, a fault may appear that the speed of drying, particularly vaporization, becomes excessively high to such a degree that handling of the substrate treatment agent on the printing press becomes difficult.

Further, in order to apply other characteristics required for the substrate treatment agent such as transfer characteristic, picture quality, maintenance characteristic, storage stability and safety, as occasion demands, not only solvent for enhancing the drying characteristic but also different solvent having a viscosity of 5 cP or more and a vapor pressure of 1 mmHg or less under the atmospheric pressure at 20° C. may be contained by a suitable amount.

It is to be noted that, as indicated by printed and cut newspaper 11 in FIG. 5, supplying of the substrate treatment agent to the web 10 by the substrate treatment agent supplying apparatus 4 is carried out only at a predetermined location (here, a printing region 13 of a photograph and printing regions 14 and 15 of an advertisement) on the printing faces (printing pages) 11a and 11b. It is to be noted that white ink may be used as an example of the substrate treatment agent to be supplied to the newspaper 11. The white ink is not supplied to a region 12 on which an article is to be printed. In particular, a printing plate for white ink ready for the required regions 13, 14 and 15 is prepared and is mounted on the printing drums 4b and 4d to carry out printing so that such a process as described above can be carried out.

It is to be noted that, while a printing region may be set as a solid printing region (tone value of 100%) on a printing plate for white ink, basic ink or special color ink, the printing region may be set also as a region which has an arbitrary halftone dot shape different from that of solid printing. In this instance, the drying speed of each ink can be raised while enhancement of the whiteness of the printing face of the web 10 or the optical density of ink is implemented to some degree.

Further, as described above, the white ink supplying apparatus 4 is provided at a location on the downstream side with respect to the dancer roller 2b which is an apparatus for varying the web-path length of the in-feed section 2 but on the upstream side with respect to the first color blanket drum nip section of the printing apparatus. Therefore, the phase of the printing plate for white ink can be easily adjusted to that of each printing plate in the printing section 6, and such printing of white ink to the required regions 13, 14 and 15 as described above can be carried out with certainty.

Since the newspaper rotary press as the offset printing press according to the first embodiment of the present invention is configured as described above, printing on the surface (printing face) of the web 10 is carried out as illustrated in the flow chart of FIG. 6.

In particular, white ink (substrate treatment agent) is first supplied to the printing face of the web 10 supplied from the paper supplying section 1 while the tension state thereof is adjusted by the in-feed section 2 by the white ink supplying section 4A of the white ink supplying apparatus 4 (step S10; substrate treatment agent supplying step). The supplying of the white ink is carried out only for the required regions 13, 14 and 15 (FIG. 5) by a printing system.

Then, the web 10 advances to the drying processing section 4B and the white ink (substrate treatment agent) on the printing face is subjected to a heating drying process by the heating apparatus 5 to form a porous layer (step S20; drying step). Then, the printing is carried out by the printing section 6 (step S30; printing step).

As described above, by carrying out the drying process for the white ink on the printing face, the porous layer 30 is formed on the printing face as shown in FIGS. 3(a) and 3(b), and therefore, if printing is carried out, then the printing ink 20 is applied to the porous layer 30 on the printing face. The printing ink 20 contains at least the pigment 21 as coloring agent, binder resin 22 and solvent 23. While an ink layer formed from the ink 20 contains all of the pigment 21, binder resin 22 and solvent 23 as seen in FIG. 3(a) immediately after the printing ink 20 is applied to the printing paper 10, the solvent 23 is removed as seen in FIG. 3(b) as the drying step advances.

At the drying step, the drying of the substrate treatment agent is achieved while infiltration of the solvent 23 into the printing paper 10 and volatilization or evaporation of the solvent 23 into the atmosphere advance at the same time.

Since the pigment 21 itself is fine if it is not mixed with the binder resin 22, part of the pigment 21 is infiltrated into clearances of the paper fibers in the printing paper 10 and is hidden from the surface in the printing region. However, since the printing ink 20 is applied to the porous layer 30 on the printing face, infiltration of the pigment 21 and the resin 22 into clearances of the paper fibers in the printing paper 10 is prevented by the porous layer 30 so that so called drydown is suppressed. Naturally, while passage of the pigment 21 through the small diameter holes 32 of the porous layer 30 is difficult, infiltration of the solvent 23 into the printing paper 10 is carried out sufficiently. Therefore, the drying of the ink is quickly carried out.

As a result, in the ink printed on the substrate treatment agent, the pigment density per a unit volume on the surface is increased. Therefore, even if the ink thickness is equal, the printing density is higher than that in an alternative case wherein the ink is printed on paper for newspaper to which the substrate treatment agent is not supplied. Therefore, the color reproduction range can be widened.

In the printing for paper for newspaper, the dot gain is remarkable particularly in an intermediate color tone of a tone value of 30 to 60% and the halftone dot area increases by 15 to 30%. As one of reasons of this, it is estimated that, since the CMYK ink runs and spreads on the surface of the printing paper along orientation of fibers of the printing paper, the size of the halftone dots increases. While, if the porous layer 30 of the substrate treatment agent is formed on the surface of the printing paper 10, then the printing paper is infiltrated quickly with the solvent components in the ink 20 applied on the porous layer 30, the pigment and the resin cannot pass the small diameter holes. Therefore, the ink 20 is concentrated on the surface of the porous layer 30. Since such concentrated ink remaining on the surface of the printing paper as just described has high viscosity and does not have a property that it actively spreads in a horizontal direction, it is estimated that the dot gain is less likely to occur.

Further, it is estimated that the strike-through is less likely to occur because advancement of the pigment 21 into clearances of the paper fibers of the printing paper 10 is blocked.

Besides, since the white pigment is used as the solid fine particles of the substrate treatment agent, the surface of the paper (web) 10 for newspaper having low whiteness is processed with the white pigment so as to obtain high whiteness and a full-color photograph (printing location 13 in FIG. 5) or advertisement (printing locations 14 and 15 in FIG. 5) is printed without causing muddiness or the like in the printing ink, and printing of the color tone to be reproduced can be implemented utilizing the high-whiteness substrate. The photograph can be printed while correctly reproducing the original picture and the advertisement can be printed while correctly reproducing the original picture thereby to implement vivid printing having a high advertisement effect.

Particularly, since the substrate treatment agent is supplied only to a photograph location or an advertisement location on the printing face, that is, to part of the printing face, the substrate processing can be efficiently carried out and the processing cost can be suppressed. Further, by not carrying out the substrate processing, there is the possibility that the article region 12 may be easy to read.

It is to be noted that preferably the whiteness of the portion, at which the substrate treatment layer is exposed, of the printing paper to which the substrate treatment agent containing the white pigment is supplied is 60% or more after the offset printing ends.

### [Result of Experiment]

FIG. 7 is a view showing a relationship between the dried film thickness and the whiteness of white ink obtained by an experiment. In this experiment, the white ink was printed on paper for newspaper having a basis weight of 42 g/m² and whiteness of 55% by the offset rotary press of the present embodiment. After the printing, paper on which the white ink was printed and different paper on which the white ink was not printed were cut out by a predetermined area and then dried at 150° C. in a dryer for two hours. After cooling to the room temperature, the white ink supplying amount per a unit area was calculated from the difference between the weights of the papers described. The white ink supplying amount after drying which is represented by the horizontal axis in FIG. 7 is indicated as a relative value taking the supplying amount upon 75% whiteness as a reference 1.

Further, the supplying amount of the white ink was adjusted through the number of rotations of the ink supplying roller. Further, the whiteness was measured using a Hunter brightness meter of JIS by irradiating a certain amount of blue light upon paper to measure the reflectance of the reflected light. Where the reflectance of magnesium oxide is determined as 100%, the ratio (%) of intensity of the reflected light from the paper surface with respect to the reflected light of magnesium oxide is represented.

While the Brightone FC-765 white of Sakata lnx is available as the white ink which can achieve high whiteness (for example, 75% whiteness or more) with a practical supplying amount (white ink thin film), the white ink is not limited to this.

Then, the white ink was supplied to paper for newspaper so that 64%, 74% and 80% whiteness were obtained and then solid printing was carried out independently (not printing for putting ink on printed ink repeatedly) with ink films of ink colors of cyan (C), magenta (M), yellow (Y) and black (K) adjusted so as to have an ink film thickness of 1 μm, and the printing density (optical density) of the solid portions was measured. FIGS. 8(a) to 8(d) illustrate the result of the measurement and are views individually illustrating a relationship between the whiteness and the solid density of the printing paper.

While a certain difference appears depending upon the color of ink as seen in FIGS. 8(a) to 8(d), it was confirmed that, also in case of whiteness of 64%, the optical density of the solid portions of the CMYK colors indicates enhancement that in a case wherein printing was carried out directly on the paper for newspaper (in case of whiteness of 55%).

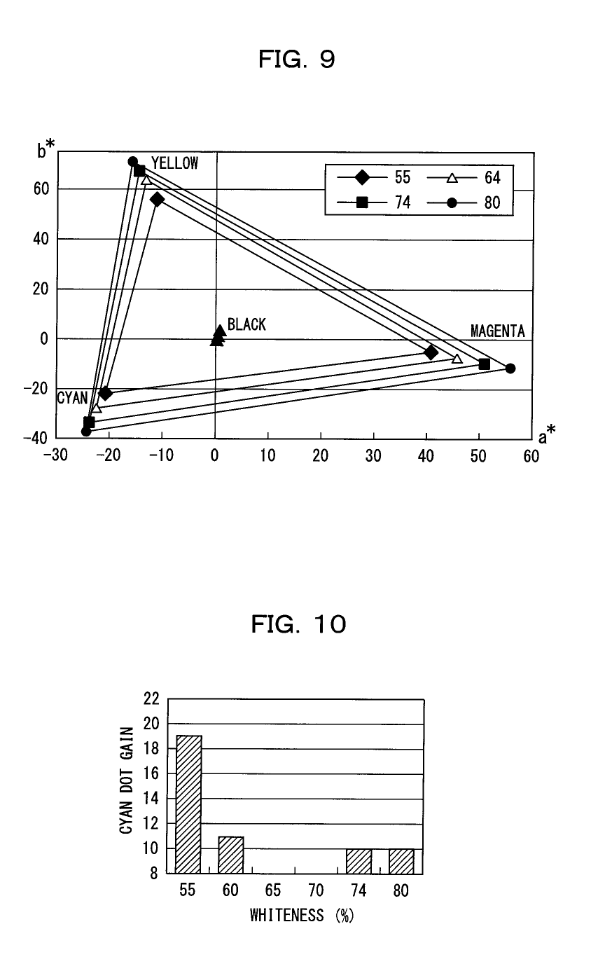

Further, the color reproduction range was measured the samples of the solid printing. FIG. 9 illustrates a result of the measurement and the color reproduction range is represented in a CIE 1976L*a*b* space. As seen in FIG. 9, it was confirmed successfully that the color reproduction range increases as the whiteness increases.

Then, the white ink was supplied to the paper for newspaper so that whiteness values of 60%, 74% and 80% were obtained, whereafter printing of a tone value of 50% was carried out with cyan (C) ink and then the dot gain was measured. The dot gain was determined by optical density measurement of the print samples. FIG. 10 illustrates a result of the measurement just described. As seen in FIG. 10, it was confirmed that, also where the whiteness is 60%, the dot gain is reduced by 8 points in comparison with paper for newspaper to which the white ink was not supplied. Also in regard to the different ink colors of magenta (M), yellow (Y) and black (K), it was confirmed that the dot gain decreases by 5 to 8 points where the whiteness is 60%.

It is to be noted that, regarding the dot gain reduction, enlargement of halftone dots by running of the ink is suppressed and, if the white ink is used as the substrate treatment agent, then the printing density increases as shown in FIG. 8. Therefore, it is estimated that increase of the contrast difference between the solid printing portion and the 50% tone value portion makes a cause of the dot gain reduction.

Further, it is recognized from the test result of the solid density in FIG. 8 and the test result of the dot gain in FIG. 10 that preferably the whiteness of the paper for newspaper to which the white ink was supplied is 60% or more.

Further, on the paper for newspaper to which the white ink was supplied so as to have whiteness of 74% and the paper for newspaper to which the white ink was not supplied, an image was printed in four overlapping colors individually at a tone value of 70% with the CMYK inks such that the totaling ink amount became 280% with totaling four printing plates. In this instance, strike-through was not observed on the paper for newspaper having the 74% whiteness while strike-through was observed on the paper for newspaper to which the white ink was not supplied.

The effectiveness of the porous layer according to the present embodiment was evidenced from the results of the experiment described above.

### Second Embodiment

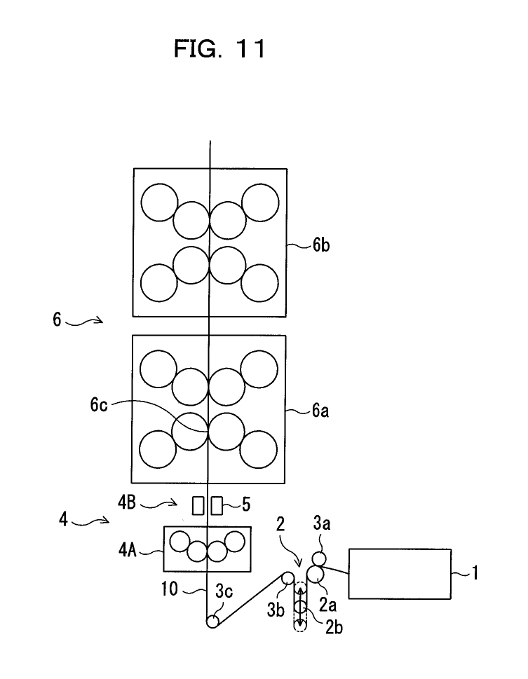

Now, a second embodiment of the present invention is described. FIG. 11 is an explanatory view showing a configuration of essential part of an offset printing press in the second embodiment of the present invention. In FIG. 11, like elements to those in FIG. 1 are denoted by like reference characters and description of the like elements is partly omitted.

While the first embodiment is configured such that the substrate treatment agent supplying apparatus (substrate treatment agent supplying section 4A and drying processing section 4B) 4 is added to an existing newspaper rotary press, the present embodiment is configured such that the substrate treatment agent supplying apparatus 4 is incorporated originally in a newspaper rotary press. In particular, as shown in FIG. 11, the substrate treatment agent supplying apparatus 4 is mounted on the upstream side of the printing section 6 including printing units 6a and 6b and so forth in a juxtaposed relationship with the printing section 6. The configuration of the other part of the present embodiment is similar to that of the first embodiment. It is to be noted that, in the present embodiment, description is given taking a case wherein white pigment is used as the solid fine particle of the substrate treatment agent as an example.

It is to be noted that, also in the present embodiment, similarly as in the first embodiment, the substrate treatment agent supplying section 4A is provided on the downstream side with respect to the dancer roller 2b which is an apparatus for varying the web-path length of the in-feed section 2 (here, however, on the downstream side with respect to the guide roller 3c for guiding the web 10 to the printing apparatus 6) but on the upstream side with respect to the blanket drum nip 6c of the first printing unit 6a of the printing apparatus 6. Therefore, the phase of a printing plate for the white ink can be easily adjusted to that of each printing plate in the printing section 6, and printing of the substrate treatment agent to the required regions 13, 14 and 15 described in the first embodiment can be carried out with certainty.

Also with such a configuration as described above, similarly to the first embodiment, the drydown is suppressed by the porous layer, and also an effect is achieved that a high-whiteness substrate by the white pigment can be utilized to achieve printing of a color tone to be reproduced.

### Third Embodiment

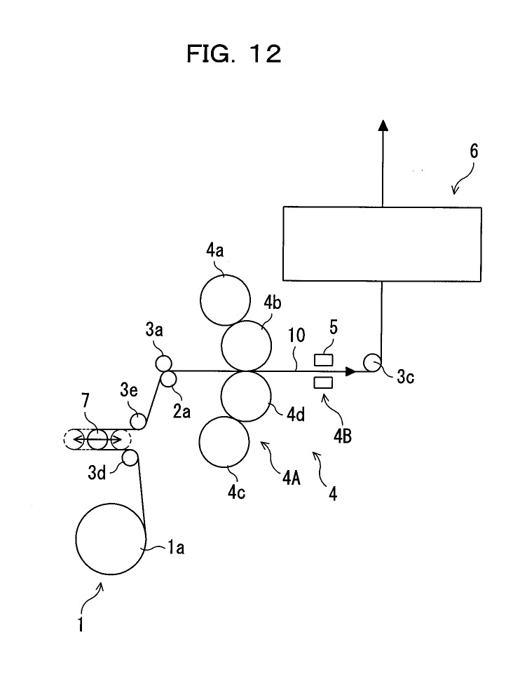

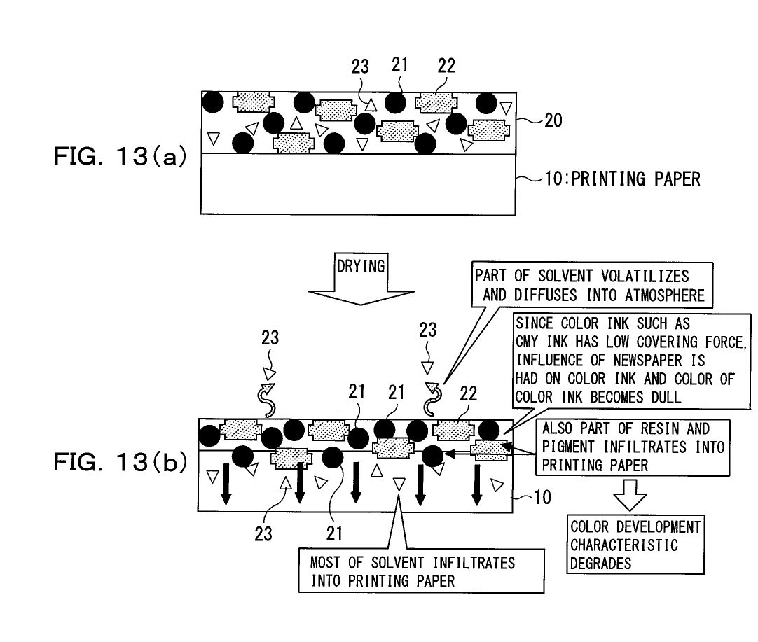

Now, a third embodiment of the present invention is described. FIG. 12 is an explanatory view showing a configuration of essential part of an offset printing press in the third embodiment of the present invention. In FIG. 12, like elements to those in FIG. 1 are denoted by like reference characters, and description of the like elements is partly omitted. Also in the present embodiment, white pigment is used as the solid fine particle of the substrate treatment agent as an example.

In the present embodiment, while the substrate treatment agent supplying apparatus 4 itself is same as those in the first and second embodiments, a portion of the printing press on the upstream side with respect to the substrate treatment agent supplying apparatus 4 is different from those in the first and second embodiments.

In particular, while the dancer roller is provided as an apparatus for varying the web-path length in the first and second embodiments, in the present embodiment, the dancer roller is not provided but a floating roller 7 is provided as an apparatus for varying the web-path length as shown in FIG. 12.

The floating roller 7 is an apparatus for absorbing variation of paper supplying tension, and if the paper supplying tension decreases upon speed up or down, pasting, emergency shutdown or the like of the rotary press, then the movement tension decreasing amount is absorbed in a direction to the left side (refer to alternate long and two short dashes line) in FIG. 12. On the contrary, if the paper supplying tension increases, then the movement tension increasing amount is absorbed in a direction toward the right side (refer to alternate long and two short dashes line) in FIG. 12.

It is to be noted that the dancer roller 2b and the in-feed roller 2a (refer to FIGS. 1 and 12) described in connection with the first and second embodiments positively detect the tension at the entrance of the printing unit and change the position of the dancer roller 2b and the circumferential speed of the in-feed roller 2a to suppress the tension variation and then stabilize the tension at the entrance of the printing unit. Further, while the dancer roller 2b and the in-feed roller 2a include a driving apparatus for driving the dancer roller 2b, the floating roller 7 does not specifically include a driving apparatus (floating roller 7 is a mere pendulum roller) and is an apparatus for absorbing tension variation. However, the floating roller 7 is common to the dancer roller 2b and the in-feed roller 2a in that it is an apparatus for varying the web-path length.

Accordingly, where the substrate process such as supplying of white ink is carried out for a required location of the web 10, the white ink supplying apparatus (substrate treatment agent supplying apparatus) 4 is disposed on the downstream side with respect to the floating roller 7 which is an apparatus for varying the web-path length in order to prevent displacement of the phase of the printing position, for which the substrate process is carried out, caused by variation of the web-path length.

Also with such a configuration as just described, similarly as in the first and second embodiments, the drydown is suppressed by the porous layer, and also an effect is achieved that a high-whiteness substrate by the white pigment can be utilized to achieve printing of a color tone to be reproduced.

It is to be noted that, where there are a plurality of [apparatus for varying the web-path length], it is preferable to dispose the substrate treatment agent supplying apparatus 4 on the downstream side with respect to the [apparatus for varying the web-path length] disposed on the more downstream side with respect to the paper supplying section toward the first color blanket drum nip section.

### [Others]

While the embodiments of the present invention are described above, the present invention is not limited to the configurations specifically described above, and variations and modifications can be made without departing from the scope of the present invention.

For example, while a newspaper rotary press is taken as an example in the foregoing description of the embodiments, the present invention can be widely applied not only to a newspaper rotary press but also to an offset printing press.

Further, even if the solid fine particles of the substrate treatment agent used is transparent, it is possible to enhance the printing density and enhance the color reproduction range by suppressing precipitation of the ink pigment 21. Further, since spreading of the ink along fibers of the printing paper can be suppressed, also the dot gain suppression effect can be achieved. Where the refractive index difference between the solid fine particles and the binder resin is small, a substrate treatment layer having transparency is formed. For example, the refractive index of polystyrene resin, methyl methacrylate resin (a kind of acrylate resin) and melamine resin which are resins generally used for ink or the like is 1.59, 1.49 and 1.60, respectively. Therefore, while white particles having a refractive index of 1.4 to 1.7 such as, for example, calcium carbonate (refractive index: 1.58), barium sulfate (refractive index: 1.64), calcium sulfate (refractive index: 1.59), silica (refractive index: 1.45), aluminum hydroxide (boehmite, refractive index: 1.65) and so forth can be applied as the solid fine particles which can be applied to transparent substrate treatment agent, the white particles are not limited to them.

Further, plural kinds of solid fine particles may be used at the same time.

Also it is a possible idea to use, as the solid fine particles of the substrate treatment agent, pigment corresponding to special color ink other than the white ink color, that is, special color inks of the basic ink colors of cyan, magenta and yellow and the ink colors of white and black. If such pigments corresponding to the specific color inks as just described are applied to the substrate, then the representation variation of the color shade drastically increases and color development which provides a very high impression can be implemented. Therefore, particularly by applying the pigment just described to advertisement, the pigment can contribute to enhancement of an advertisement effect.

Further, plural kinds of substrate treatment agent may be used. In particular, a plurality of substrate treatment agent supplying apparatus are provided so as to individually carry out substrate processes different from each other. Consequently, substrate processes different from each other such as enhancement of the whiteness, enhancement of lightness of the colors other than the white color, surface smoothing and so forth can be carried out for the same paper face, and various requests for printing can be satisfied.

Further, in the embodiments described above, while the substrate treatment agent is supplied to all regions in regard to a photograph region and an advertisement location region on the printing face, the substrate treatment agent may be supplied partly to a required portion from within the photograph region or the advertisement region. In particular, the substrate process is not carried out for a region in which the substrate is little exposed. Consequently, the substrate process can be carried out with a higher efficiency and the processing cost can be suppressed further. It is to be noted that, also in this instance, it is preferable to assure a rather great contour for the substrate process to carry out the substrate process also for a boundary portion of the region in which the substrate is little exposed because of presence of the ink so that the portion for which the substrate process is not carried out is not exposed.

1. A printing method by an offset printing press, comprising:
a substrate treatment agent supplying step of supplying substrate treatment agent containing solid fine particles and a binder component at least to a printing face of printing paper;
a drying step of drying the printing face to which the substrate treatment agent is supplied; and
a printing step of carrying out offset printing on the printing face; and wherein
by drying the printing face at the drying step, a porous layer having a great number of holes with a smaller diameter than that of particles of pigment contained in printing ink is formed from the solid fine particles and the binder component contained in the substrate treatment agent.

2. The printing method by an offset printing press as claimed in claim 1, wherein a weight ratio between the solid fine particles and the binder component contained in the substrate treatment agent, as represented by solid fine particles/binder component, is 20/1 to 2/1.

3. The printing method by an offset printing press as claimed in claim 1, wherein a primary particle size of the solid fine particles is 0.05 to 0.5 μm.

4. The printing method by an offset printing press as claimed in claim 1, wherein the solid fine particles of the substrate treatment agent are white pigment.

5. The printing method by an offset printing press as claimed in claim 1, wherein the printing paper is low-whiteness printing paper and the offset printing press is a newspaper rotary press.

6. An offset printing press for carrying out offset printing on printing paper, comprising:
a substrate treatment agent supplying section provided on the upstream side with respect to a blanket drum nip section for a first color of a printing section and adapted to supply substrate treatment agent containing solid fine particles and a binder component to a printing face of the printing paper; and
a drying processing section provided on the upstream side with respect to the blanket drum nip section for the first color of the printing section but on the downstream side with respect to said substrate treatment agent supplying section and adapted to carry out a drying process for the substrate treatment agent supplied to the printing face to form a porous layer having a great number of holes with a smaller diameter than that of particles of pigment contained in printing ink from the solid fine particles and the binder component contained in the substrate treatment agent.

7. The offset printing press as claimed in claim 6, wherein a weight ratio between the solid fine particles and the binder component contained in the substrate treatment agent, as represented by solid fine particles/binder component, is 10/1 to 5/1.

8. The offset printing press as claimed in claim 6, wherein a primary particle size of the solid fine particles is 0.05 to 0.5 μm.

9. The offset printing press as claimed in claim 6, wherein the solid fine particles of the substrate treatment agent are white pigment.

10. The offset printing press as claimed in claim 6, wherein the printing paper is low-whiteness printing paper and the offset printing press is a newspaper rotary press.

11. The printing method by an offset printing press as claimed in claim 2, wherein a primary particle size of the solid fine particles is 0.05 to 0.5 μm.

12. The printing method by an offset printing press as claimed in claim 2, wherein the solid fine particles of the substrate treatment agent are white pigment.

13. The printing method by an offset printing press as claimed in claim 3, wherein the solid fine particles of the substrate treatment agent are white pigment

14. The printing method by an offset printing press as claimed in claim 2, wherein the printing paper is low-whiteness printing paper and the offset printing press is a newspaper rotary press.

15. The printing method by an offset printing press as claimed in claim 3, wherein the printing paper is low-whiteness printing paper and the offset printing press is a newspaper rotary press.

16. The printing method by an offset printing press as claimed in claim 4, wherein the printing paper is low-whiteness printing paper and the offset printing press is a newspaper rotary press.

17. The offset printing press as claimed in claim 7, wherein a primary particle size of the solid fine particles is 0.05 to 0.5 μm.

18. The offset printing press as claimed in claim 7, wherein the solid fine particles of the substrate treatment agent are white pigment.

19. The offset printing press as claimed in claim 8, wherein the solid fine particles of the substrate treatment agent are white pigment.

20. The offset printing press as claimed in claim 7, wherein the printing paper is low-whiteness printing paper and the offset printing press is a newspaper rotary press.
